(19) United States
(12) Patent Application Publication
(10) Pub. No.: US 2005/0086225 A1
(43) Pub. Date: Apr. 21, 2005

(54) Apparatus and method for searching a directory of stored items

(76) Inventors: Xiaoming Cheng, Sunnyvale, CA (US); Jun Qiu, Beijing City (CN)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/687,025

(22) Filed: Oct. 15, 2003

(51) Int. Cl. G06F 17/30

(52) U.S. Cl. 707/6

(57) ABSTRACT

The present invention is generally directed to an apparatus and method for performing a unique searching and/or sorting algorithm. In accordance with one embodiment, a searching algorithm is implemented by performing a digit-by-digit comparison of a received number with a directory of stored numbers, by comparing digits in a generally right to left (or least significant to most significant) direction. In one system having a mobile phone that implements an embodiment of the invention, digits of a base phone number are compared before digits of a prefix, such as an area code or country code of the phone number.

### FIELD OF THE INVENTION

The present invention generally relates to searching and sorting methodologies for computers and electronic devices, and more particularly to an apparatus and method for searching a directory of stored items.

### BACKGROUND

A variety of portable electronic devices are known that perform searching and/or sorting algorithms. As one example, mobile telephones typically perform a searching algorithm to search a directory of stored numbers to determine whether a received number (e.g., received from caller identification information) is stored within the directory.

As is known, users of mobile phones frequently store the names and numbers of colleagues and acquaintances in a directory or other listing that is stored in a memory that is associated with the mobile phone. When a call is received from a number that is stored in the associated directory, the corresponding name is often retrieved and displayed on the display to the user, so that the user is apprised of the identity of the caller before answering the call. If the number received through the caller identification information is not located within the directory, then the phone may merely display the number on the display to the user. There are various shortcomings, however, in these systems.

For example, an incoming call may originate from a caller that is stored in the directory, but may not be properly identified in the searching algorithm. This may happen for a variety of reasons, including a mismatch in the format of the number as stored, in comparison to the format of the number received through caller identification. As one example, if the area code of the number is not stored in the directory, then the number may not be properly identified in the searching algorithm.

Also, known searching algorithms are often inefficient and slow. Others often over-consume power, which makes them less desirable for use in battery-operated devices, where power conservation is important.

### SUMMARY OF THE INVENTION

Certain objects, advantages and novel features of the invention will be set forth in part in the description that follows and in part will become apparent to those skilled in the art upon examination of the following or may be learned with the practice of the invention. The objects and advantages of the invention may be realized and obtained by means of the instrumentalities and combinations particularly pointed out in the appended claims.

To achieve certain advantages and novel features, the present invention is generally directed to an apparatus and method for performing a unique searching and/or sorting algorithm. In accordance with one embodiment, a searching algorithm is implemented by performing a digit-by-digit comparison of a received number with a directory of stored numbers, by comparing digits in a generally right to left (or least significant to most significant) direction. In one system having a mobile phone that implements an embodiment of the invention, digits of a subscriber phone number are compared before digits of a prefix, such as an area code or country code of the phone number.

### DESCRIPTION OF THE DRAWINGS

The accompanying drawings incorporated in and forming a part of the specification illustrate several aspects of the present invention, and together with the description serve to explain the principles of the invention. In the drawings:

FIG. 1A is a block diagram illustrating certain components of an inventive embodiment implemented in a mobile phone for attachment with a SIM card containing a stored directory of names and numbers.

FIG. 1B is a diagram similar to FIG. 1A, but illustrating a mobile phone containing a directory of names and numbers stored in an internal memory.

FIGS. 2A, 2B, and 2C are block diagrams illustrating various formats and segmentations of phone numbers stored in differing formats.

FIGS. 3A and 3B illustrate non-limiting examples of names and numbers that may be stored in a directory or listing that is searched by an algorithm, in accordance with embodiments of the present invention.

FIG. 4 is a flowchart illustrating certain steps of an embodiment of the present invention.

FIG. 5 is a flowchart illustrating the top-level operation of an alternative embodiment of the present invention.

FIG. 6 is a flowchart illustrating the top-level operation of an alternative embodiment of the present invention.

FIG. 7 is a diagram illustrating certain components in a portable electronic device, constructed in accordance with an embodiment of the invention.

FIG. 8 is a block diagram illustrating certain components of a portable electronic device constructed in accordance with another embodiment of the present invention.

FIGS. 9A and 9B are block diagrams illustrating certain components of a portable electronic device constructed in accordance with another embodiment of the present invention.

### DETAILED DESCRIPTION

Having summarized various aspects of an embodiment of the present invention, reference will now be made in detail to the description of the invention as illustrated in the drawings. While the invention will be described in connection with these drawings, there is no intent to limit it to the embodiment or embodiments disclosed therein. On the contrary, the intent is to cover all alternatives, modifications and equivalents included within the spirit and scope of the invention as defined by the appended claims.

It is noted that the drawings presented herein have been provided to illustrate certain features and aspects of embodiments of the invention. It will be appreciated from the description provided herein that a variety of alternative embodiments and implementations may be realized, consistent with the scope and spirit of the present invention.

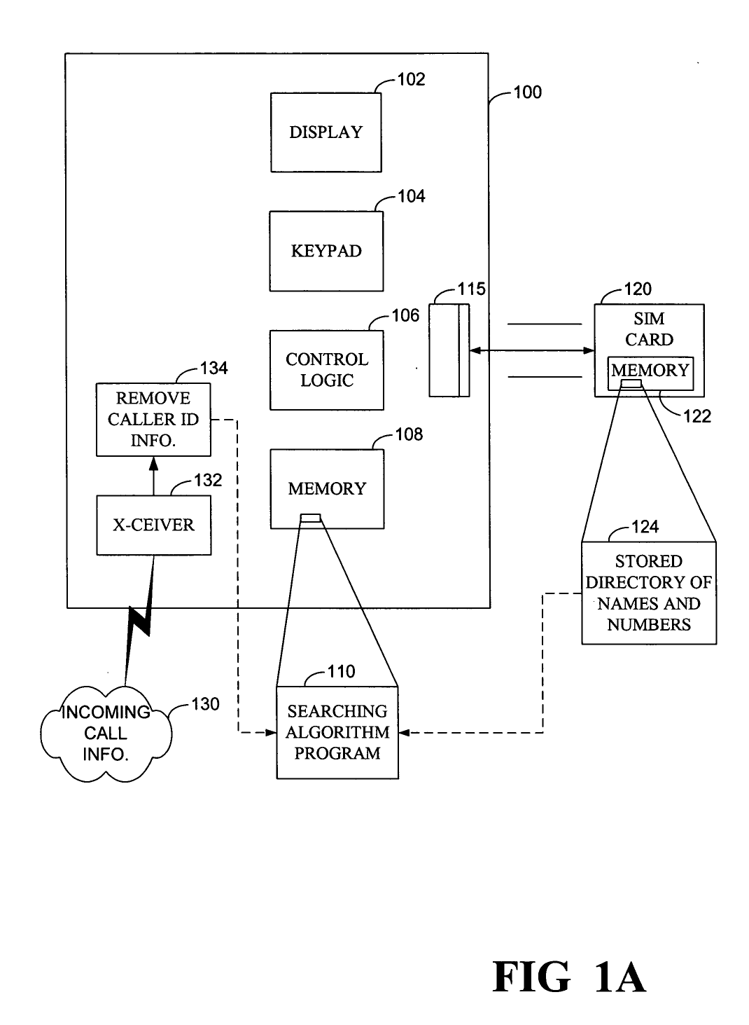

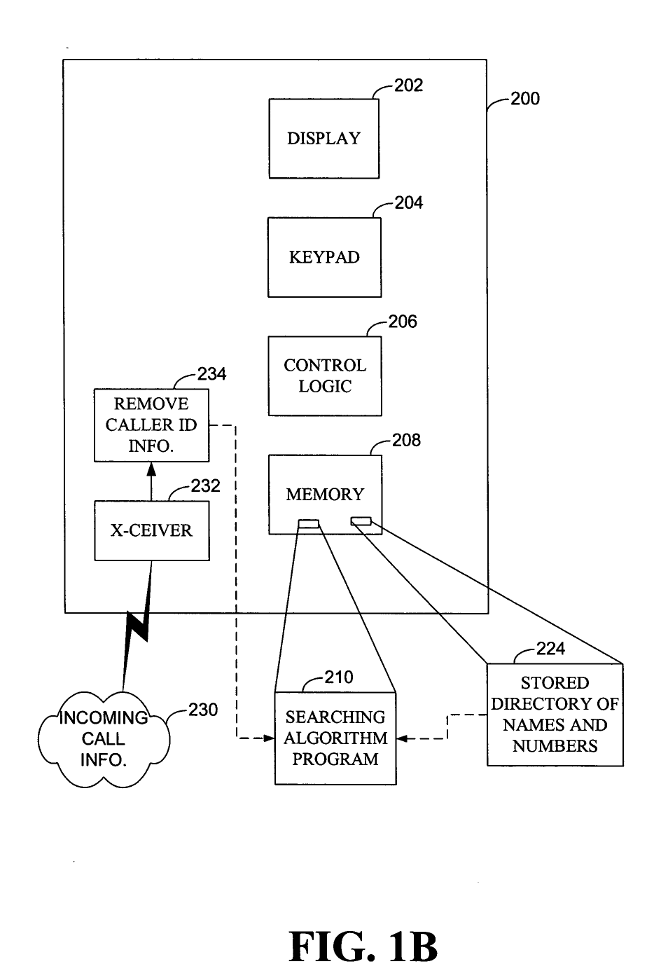

Reference is now made to FIGS. 1A and 1B, which illustrate two slightly differing embodiments of the present invention, wherein like reference numerals are used to designate like components. In the embodiment of FIG. 1A, a mobile phone 100 is provided. As is known, the mobile phone may include a display 102 for displaying visual information to a user, a keypad 104 for providing an input mechanism for the user, and control logic 106 for carrying out various functions and control operations of the mobile phone 100. The control logic 106 may be implemented in discrete hardware, may be implemented using a microprocessor or microcontroller, or may be implemented using a specially designed, application specific integrated circuit. The control logic 106 may also be implemented, in part, through software or firmware. The display 102, keypad 104, and control logic 106 are conventional components that may be implemented in a variety of ways, consistent with the scope and spirit of the invention.

FIG. 1A also illustrates an internal memory 108. The memory 108 may store a variety of information and/or functional or control code. Among other information or contents stored in the memory 108, the memory 108 may include program code 110 for controlling the execution of a searching algorithm. This program, consistent with the embodiment of FIG. 1A, may take on a variety of forms and may be implemented in a variety of ways, consistent with the embodiments described further herein.

The embodiment of FIG. 1A also illustrates an internal circuit card 120 (such as a SIM card) that may be electrically coupled with the mobile phone 100 through a connector 115. As is known, the SIM cards may be utilized to store personal information, such as directory listings, that are unique to users. In configurations such as that illustrated in FIG. 1A, SIM cards may be easily portable and associable with multiple mobile phones. That is, through the use of an integrated circuit card 120, such as the SIM card of FIG. 1A, stored information that is unique to the user may be readily transportable to other mobile phones, merely by removing the SIM card 120 and connecting it with another mobile phone. In such an embodiment, the SIM card 120 may include an on-board memory 122, which memory 122 may contain a stored directory of names and numbers 124. When the SIM card is coupled to the mobile phone 100 through the connector 115, the searching algorithm program 110 may be used by the control logic 106 for searching the stored directory of names and numbers 124.

In this regard, and as is further illustrated, certain information 130 is embodied in an incoming call to a given mobile phone 100, which is received by an internal cellular transceiver 132. In a manner that is known, the mobile phone 100 may discriminate among this received information to ensure that inbound call is destined for the given mobile phone 100. Other circuitry and/or logic 134 may be provided to extract caller identification information from the incoming call information. The searching algorithm 110 may utilize this caller identification information in comparison to the numbers stored in the directory 124. The methodology implemented by the various algorithms of the present invention will be described in more detail herein.

As illustrated in the embodiment of FIG. 1B, a mobile phone 200 may include the stored directory of names and numbers 224 in the internal memory 208. In this regard, the mobile phone 200 of FIG. 1B is a stand-alone device, and does not include a SIM card connection. Other components and features, however, of mobile phone 200 may operate in the same manner as that described in connection with the mobile phone 100 of FIG. 1A. Further, and though not specifically illustrated in the drawings, a mobile phone may have both (1) circuitry to accommodate a SIM card that stores a directory of names and numbers, as well as (2) an internal memory storing a directory of names and numbers. Thus, one embodiment may search both such directories.

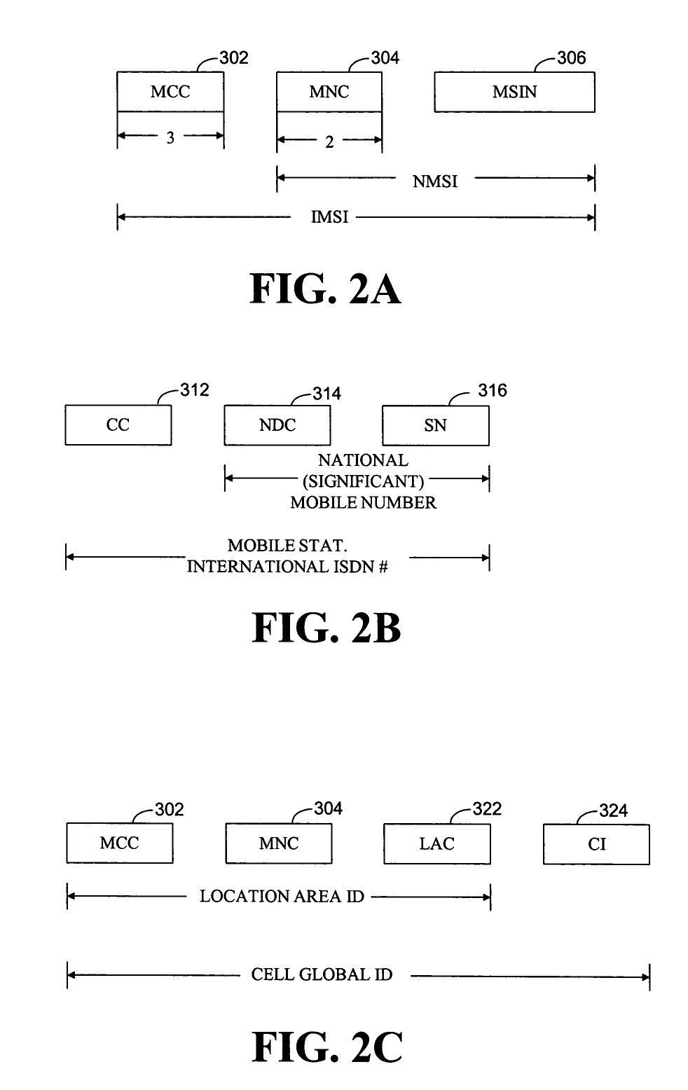

Various embodiments of the invention operate to carry out a searching algorithm which compares a received number with a plurality of stored numbers by comparing the numbers one digit (or one segment) at a time, in a direction from right to left. In the context of a mobile phone, the numbers that are compared may be received and/or stored in a variety of formats. FIGS. 2A-2C illustrate three compatible formats. However, consistent with the scope and spirit of the invention, a variety of other formats may be implemented as well. For example, FIG. 2A illustrates a format for a unique international mobile subscriber identity (ISMI). As is known, the ISMI is the ID sent from a mobile phone upon power-up for registration. After power-up, a mobile phone may receive a number stored or transmitted in a variety of formats, including the formats of FIG. 2A, which contains essentially three components. The first component 302 is the mobile country code (MCC), which consists of three digits. The MCC 302 uniquely identifies the country of domicile of the mobile subscriber. The second part is the mobile network code 304 (MNC), which consists of two digits for GSM (global system for mobile communications) applications. The MNC 304 identifies the home GSM public land mobile network (PLMN) of the mobile subscriber. Finally, the third part 306 is the mobile subscriber identification number (MSIN), which identifies the mobile subscriber within a GSM PLMN.

An embodiment of the present invention may also be operable with numbers received or stored in the national mobile subscriber identity (NMSI) format. As designated in FIG. 2A, this format comprises only the MNC 304 and MSIN 306 components of the IMSI format. As is known, numbers stored in this format consist of numerical characters (or digits) ranging from zero to nine only.

In accordance with other embodiments of the invention, numbers may be received or stored in a mobile station international PSTN/ISDN number (MSISDN) format, as illustrated in FIG. 2B. Numbers in this format are generally defined by three segments. The first segment 312 defines a country code of the country in which the mobile station is registered. The remainder of the number defines a national mobile number, which consists of a national destination code (NDC) 314 and a subscriber number (SN) 316. For GSM applications, a national destination code is allocated to each GSM PLMN. In some countries, more than one NDC may be required for each GSM PLMN. As is known, the composition of the MSISDN is such that it may be used as a global title address in the signaling connection control part (SCCP) for routing messages to the home location register of the mobile station. The country code 312 and the national destination code 314 typically provide such routing information. If, however, further routing information is required, it is typically contained in the first few digits of the subscriber number 316.

Another embodiment of the present invention may operate to search numbers that are received and stored in a cell global identification format. FIG. 2C illustrates the components of such a format. In this regard, a number stored in such a format is typically defined by four segments. The first two segments, as illustrated in connection with FIG. 2A, include a mobile country code 302 and mobile network code 304 segments. It further includes a local area code (LAC) 322 segment. The local area code segment is typically a fixed length code (two octets in length), which identifies a location area within a GSM PLMN. Collectively, these three segments define a location area ID. A fourth segment 324 defines a cell identity (CI) to the location area identification. The cell identity is typically defined by a fixed length of two octets.

The numbering formats illustrated in FIGS. 2A-2C are provided merely for purposes of illustration, and should not be deemed to be limiting upon the invention. Indeed, the concepts and teachings of the present invention apply to searching and sorting algorithms for numbers or other characters stored in a variety of formats and in a variety of fields of application. One embodiment of the present invention applies these inventive teachings to the field of mobile telephones. However, the inventive concepts are readily applicable to other fields and technologies as well.

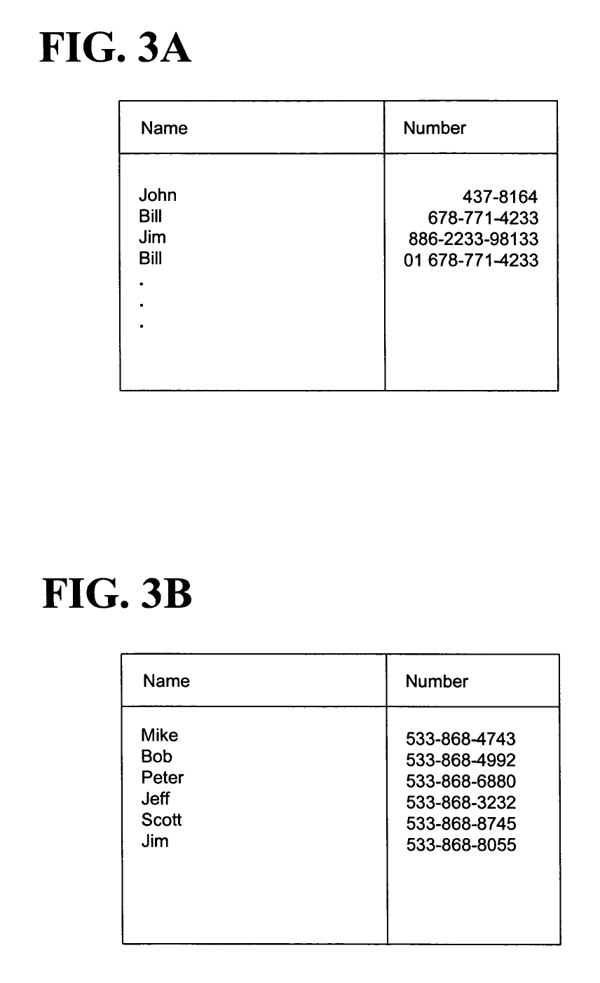

In keeping with the description of the present invention, as applied to the field of mobile or other telephone directory searching, reference is made briefly to FIGS. 3A and 3B, which illustrate partial directory listings of names and numbers that may be stored in a phone directory. Purely for illustration purposes, FIG. 3A shows a portion of a directory listing having four names and associated stored numbers. The numbers may be stored at the specific direction of the user, and as such may be stored in inconsistent formats. Consider, for example, the first two entries. The first entry stores a number associated with the name “John.” In the illustrated embodiment, only the subscriber number portion of this number is stored. In contrast, the second entry stores a number having both subscriber number and area code, or national destination code, information. When a number is received from caller identification information, that number may include both national destination code and subscriber number information. Depending upon the implementation of the searching algorithm, when such a number is received, the first entry in the illustration of FIG. 3A may be deemed to be a match (assuming the subscriber numbers are identified as a match) or not (since the stored number does not include area code or national destination code information). The third entry (“Jim”) includes a stored number in international format, having a country code designation of “886,” which is the country code identifier for Taiwan. The fourth entry, in comparison to the second entry, reflects a duplicative entry for the second entry. In this regard, and as can be seen, the subscriber number and area code, or national destination code, portions are the same. However, the fourth entry also includes a country code that has been stored as a part of the number.

Reference is now made to FIG. 3B, which illustrates another example of a partial directory listing of names and numbers. In the example illustrated in FIG. 3B, the number formats are all identical, having area code, or national destination code, and subscriber numbers stored. The prefixes for each of the numbers illustrated in the example of FIG. 3B are all the same as well. This would be a very common occurrence in situations where, for example, work phone numbers are stored for a number of colleagues. Typically in a corporate setting, the area code and subscriber number prefix are the same, with the numbers differing only by extension numbers. As can be readily verified, prior art systems would search such a directory digit by digit proceeding from left to right. By way of example, if the number “533-868-8745” were received, each of the six entries illustrated in FIG. 3B would be identified as possible matches for the received number, through the first six digit comparisons. On the seventh comparison, such a searching algorithm would identify the last two entries (“Scott” and “Jim”) as potential matches, eliminating the remainder of the numbers. Finally, on the eighth digit comparison, only the entry of Scott would be remaining.

In accordance with an embodiment of the present invention, wherein the searching is performed on a digit-by-digit basis from a right to left direction, the first digit comparison (comparing the least significant digit of “5”) would eliminate all directory entries illustrated in FIG. 3B, except the last two entries of Scott and Jim. The second digit comparison, however, would eliminate the last entry of Jim, leaving only the entry of Scott as a potential matching candidate. The comparison of the remainder of the digits, having only one entry to compare with, could be performed very quickly. This results in both power savings (particularly important for portable electronic devices), as well as a time savings in the algorithm execution.

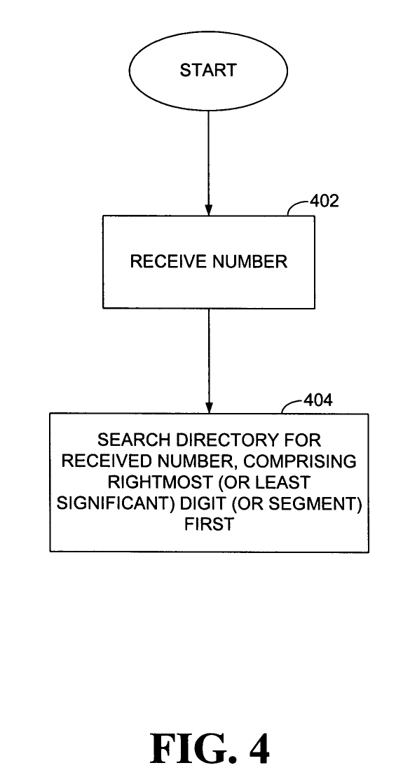

Reference is now made to FIG. 4, which is a flowchart illustrating the top-level operation of one embodiment of the invention. In accordance with the embodiment illustrated in FIG. 4, a number is received (step 402) and a search is made of a directory of numbers to determine whether the received number exists in the directory of numbers (step 404). More specifically, step 404 searches the directory of stored numbers by comparing the rightmost digit of the received number with the rightmost digit of each number stored in the directory. For those numbers in the directory having matching rightmost digits, the search is advanced by comparing the next rightmost digit of the received number with the reduced set of stored numbers. This process continues until either: (1) a determination is made that the received number does not exist in the directory, or (2) the received is identified in the directory. Thereafter, conventional steps, such as displaying a name or other information associated with the number, may be performed.

With regard to the broad steps illustrated in FIG. 4, step 402 (receiving a number) may be performed in a variety of ways. In accordance with one embodiment, this step is performed by obtaining caller identification information from inbound signaling information received at a mobile phone. The caller identification information may be in a variety of formats, with the formats illustrated in FIGS. 2A-2C providing non-limiting and non-exclusive examples of such formats. The step 402 of receiving the number may also be performed by entering a number from a keypad, receiving a number over a wired connection (such as in a non-mobile phone embodiment), as well as a variety of other ways, consistent with the scope and spirit of the present invention.

With regard to the step 404 of searching the directory for the received number, the step comprises searching the directory digit by digit, beginning with the rightmost digit and moving leftward. In this regard, it is contemplated that there is a greater probability of duplication of digits near the left-hand side (such as area code, local destination code, country code, or other prefixes that may be common to a number of stored entries). As used herein, the term digit implies a single digit of a number or single character, such as 0 through 9 of a base ten number. Consistent with the scope and spirit of the embodiment of FIG. 4, in addition to searching a plurality of stored numbers in a directory on a digit-by-digit basis, a received number may be compared against a plurality of numbers in a stored directory on a segment-by-segment basis as well. In this regard, a segment is defined as a plurality of digits, and the length of a segment may be arbitrarily chosen and may vary from embodiment to embodiment. For example, in one embodiment a segment may comprise two digits, while in another embodiment a segment may comprise three digits, while in another embodiment a segment may comprise four digits, etc. In yet another embodiment, a segment may comprise only a single digit. Comparing numbers on a segment-by-segment basis may expedite the searching process by more quickly eliminating non-matching numbers.

In this regard, and returning briefly to the example of FIG. 3B, if a received number of “533-868-8055” were compared against the various directory entries, in the previous example, it took two comparison steps to eliminate all but the last entry (Jim). If, however, a segment of two (or more) digits were selected, all numbers except the last entry could be eliminated during the first searching/comparison cycle.

It should be further appreciated that a variety of implementation details will be readily apparent to those skilled in the art, based on the description provided herein, but need not be described in detail herein. For example, depending on the model and capabilities of a given mobile phone, a user may be able to enter or store numbers in a directory by including spaces or dashes to separate groups of digits for improved readability. Non-integer digits such as these may be, in some embodiments, ignored by the searching routine. Further, in other embodiments, logic (not shown) may be provided to standardize (automatically) the format of stored numbers. For example, if a user input only a subscriber number for storing in a directory, the phone may be equipped with logic to automatically pad the subscriber number entered by the user with a default area code. Such a default area code may be generated based upon an inspection of the remainder of the directory to utilize the area code that is most frequently used for the remaining numbers. Alternatively, a default area code may be chosen based upon a home area code of the mobile phone itself. In this regard, the mobile phone may be defined by its own identification phone number (i.e., the number another user must dial to connect to that phone). Thus, the default area code or other prefix may be set to be the same as the area code or other prefix of the given mobile phone.

In yet another embodiment, a phone may be equipped to maximize the number of entries that may be stored by removing area code or other prefix information from numbers stored from a user, when those prefixes match a given default prefix for that phone. In such an embodiment, a user may enter, for example, phone number “678-555-7070” for storage into a directory. If “678” is the default area code for that particular phone, then the remaining portion of the number (555-7070) may be all that is stored into the directory. Upon a later step of receiving a number and comparing it to the number stored in the directory, the phone may automatically append the default prefix to all numbers retrieved from the directory that do not have a prefix stored with the number.

It should be appreciated that the foregoing, and in a variety of other implementation details, may be utilized with various embodiments of the invention, consistent with the scope and spirit of the claims appended hereto.

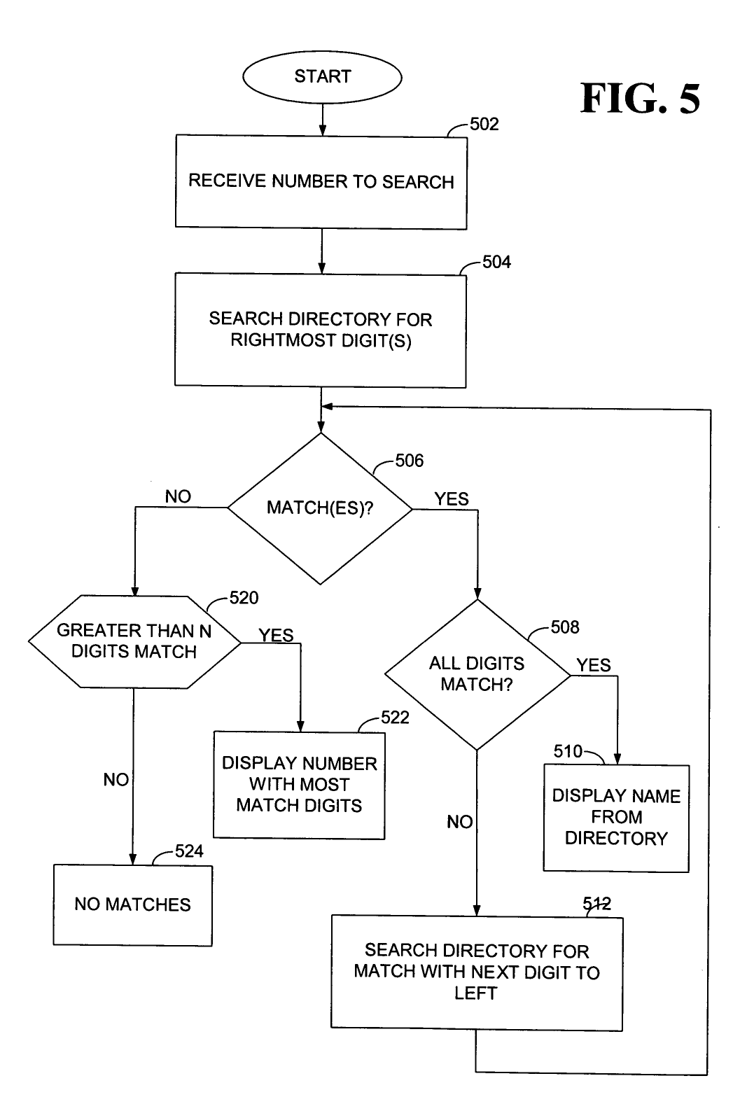

Reference is now made to FIG. 5, which is a flowchart illustrating the top-level operation of yet another embodiment of the present invention. This embodiment illustrates one potential manner of handling situations where a number of digits are found to match, but not the entire number. As illustrated, a number is received (step 502) to be searched. Thereafter, the method searches the rightmost digit (or digits if searching on a segment-by-segment basis) of a directory of stored numbers for matches (step 504). In step 506, a determination may be made as to whether any of the stored numbers have rightmost digit(s) that matches the rightmost digit(s) of the received number. If so, a determination may be made as to whether all digits match (step 508). This step effectively determines whether all digits of the received number have been compared. If so, and all digits are determined to match an entry in the directory, then the method may display a name from the directory that is associated with the stored number (step 510). If not all digits have been compared, then the method may proceed to step 512 where the comparison digit is moved to the next digit (or digits) to the left of the digit(s) previously compared. The search of step 512 is limited to the directory entries that were determined to have matching digits in the previous search step. Thereafter, the method returns to step 506 where the previously-described comparison/determination was made.

If the determination of step 506 resolves to “no”, then a determination may be made as to whether at least a predetermined number (n) of digits of the received number did match one or more directory entries (step 520). If so, the numbers and/or associated names of the matching stored numbers may be displayed to the user (step 522). If not, the method may reach the conclusion that there are no matching entries (step 524).

An advantage to an embodiment such as that illustrated in FIG. 5, and particularly the step of displaying all closely (but not precisely) matching entries may be useful when, for example, a user inputs a number from a keypad to locate the name or numbers of person stored in the directory. In this regard, a user may not remember a number precisely, but may remember most digits. An embodiment like that of FIG. 5 could be utilized to facilitate the retrieval of such numbers or other information from a stored directory.

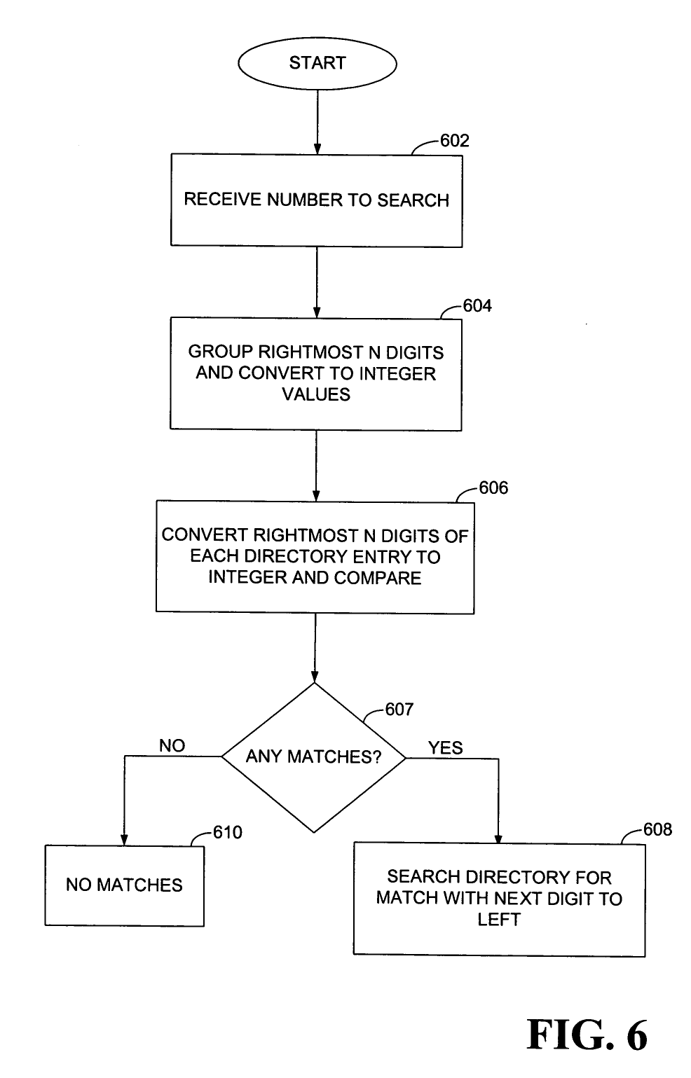

Reference is now made to FIG. 6, which is a flowchart illustrating the top-level functional operation of another embodiment of the invention. As in previous embodiments, the method may begin by receiving a number to search (step 602). The method may then group a predetermined number (n) of digits, which correspond to the rightmost digits of the received number, and convert those digits into an integer value (step 604). The method may then, likewise, convert the rightmost n digits of each directory entry to an integer value for comparison with the converted values of the received number (steps 606 and 607). Such a step may be, in some hardware platforms, desirable in that it may facilitate the comparison process by allowing a multi-digit integer comparison in one step. Stated another way, the steps of converting multiple digits to an integer value and then making an integer comparison may be executed more quickly on certain hardware platforms than a digit-by-digit comparison (or even a segment by segment comparison). For all matching entries, a search and comparison may continue moving in a leftward direction (step 608). For such a step, the continued comparison may be conducted on a digit-by-digit basis as described above, or may likewise be carried out by converting a next predetermined group of digits into an integer value and comparing. Otherwise, if step 607 resolves to “no”, the method may determine that there are no matching entries in the stored directory (step 610).

The foregoing examples have been provided for illustration only, and are not deemed to be limiting upon the scope and spirit of the invention. Indeed, an understanding of the foregoing examples illustrates the breath of the invention.

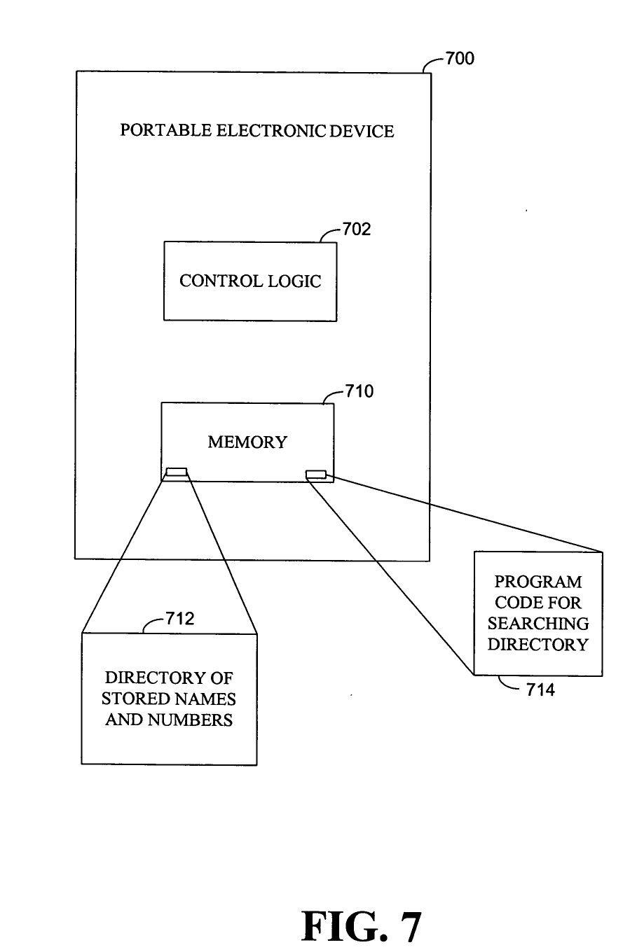

Reference is now made to FIG. 7, which is a block diagram illustrating certain components of an embodiment of the invention as applied to a portable electronic device 700. As in the previous embodiments, the portable electronic device 700 may include control logic 702 for carrying out certain functional operations. The device 700 may also include an internal memory 710 for storing both a directory of stored numbers and/or other associated information, as well as program code for searching the directory 712 for a given (received) number. The structure and format of the directory 712 may be in a variety of formats as described above. Likewise, the program code for searching the directory may be structured to operate in a variety of ways, as described in the various embodiments above as well. The portable electronic device may include mobile telephones, but may also encompass other electronic devices (PDAs, notebook computers, etc.) that may implement a searching algorithm that operates in a right-to-left fashion as described herein.

It should be appreciated from the foregoing that embodiments of the invention may be embodied in methods, for implementation in a mobile phone, for searching a directory of stored entries, comprising a plurality of phone numbers in order to associate a received number with a stored directory entry. The method may comprise the steps of receiving a number, selecting a rightmost digit of the received number as a current comparison digit, comparing the current comparison digit with a corresponding digit of each of a plurality of numbers stored in the directory, and ending the search if no matching digits are identified. If, however, matching digits are identified in the numbers stored in the directory, then the method may select, as a current comparison digit, a digit to the immediate left of the previous current comparison digit and repeat the comparison step above until all (or a predetermined number) digits of the received number have been compared against the plurality of numbers stored in the directory.

A similar embodiment may be implemented to compare a received number with a plurality of stored numbers on a segment-by-segment basis, as opposed to a digit-by-digit basis. As described above, a segment may comprise a plurality of digits.

In another embodiment, a mobile phone may be provided comprising logic to store a number in a directory either contained within or associated with the mobile phone. The number that is stored comprises a base number and at least one prefix extension (such as an area code, local destination code, country code, etc.). Logic may also be provided to compare a first prefix extension with a first corresponding default prefix extension. As described above, a default prefix extension may be the corresponding prefix defining the current phone, a corresponding prefix of the majority of the numbers currently stored in the directory, or a default prefix defined in some other fashion. The mobile phone of this embodiment may also include logic responsive to a match determined by the compare logic, to store the base number in the directory but not store the first prefix extension in the directory. In this regard, if a user is attempting to store a prefix that matches the default prefix of the mobile phone, then such prefix information need not be stored in the directory of stored numbers. Likewise, additional logic may be provided to append the default prefix to numbers stored in the directory that are not stored with corresponding prefix extensions. In such an embodiment, it may assumed that any number stored in the directory not having a corresponding prefix extension should be assigned a default prefix extension.

As previously mentioned, embodiments of the invention may be implemented in a variety of ways. The following is pseudo code of an algorithm for comparing a received number Ka with a stored number Kb. In the pseudo code algorithm below, it is assumed that the format and segmentation of the numbers Ka and Kb are known and equal. That is, prior to reaching the comparison algorithm illustrated below, certain other comparisons have been done to verify consistent formatting and segmentation of the numbers. Further, it should be appreciated that the number Kb illustrated below may be illustrative of only one number in a listing of numbers stored in a directory, and that similar comparisons may be made for all such numbers in the stored directory. For purposes of nomenclature, assume that LKa and LKb refers to the length of number Ka and the length of number Kb (in digits), respectively. Further assume that Ka and Kb comprise K segments having lengths L1, L2 . . . LK.

If segmentation is known
Then

Begin
J=1
L=L1
Repeat
If J>K

Then end (Ka<Kb or Ka>Kb)
Else
If LKa=L
Then J=J+1, L=L+LJ, continue Repeat
Else

If LKa=L
Then break Repeat
Else end (Ka<Kb or Ka>Kb)

End of Repeat
J=1
L=L1
Repeat
If J>k
Then end (Ka<Kb or Ka>Kb)
Else

If LKb>L
Then J=J+1, L=L+LJ, continue Repeat
Else

If LKa=L
Then break Repeat
Else end (Ka<Kb or Ka>Kb)

End of Repeat

End
If LKa>LKb
Then

If Ka[LKb .. LKa]=C[LKb .. LKa]
Then end (Ka=Kb)
Else end (Ka<Kb or Ka>Kb)

Else

If Kb[LKa .. LKb]=C[LKa .. LKb]
Then end (Ka=Kb)
Else end (Ka<Kb or Ka>Kb)

Finish

In the foregoing pseudo-code segment, C (of C[LKb . . . LKa]) may represent a complete number with all default prefixes. In one embodiment, only the default prefixes may be significant in comparison. The rest digits may just be the place-holders and not taken into comparisons.

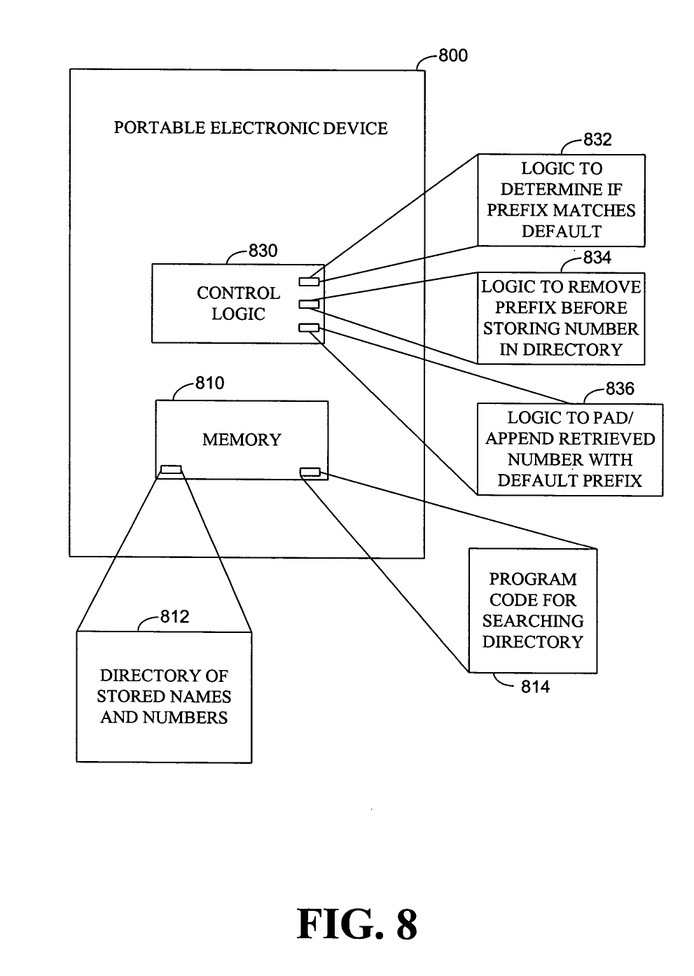

Reference is now made to FIG. 8, which is a block diagram depicting certain components of a portable electronic device constructed in accordance with another embodiment of the invention. As previously mentioned, one embodiment of the invention may be configured to conserve memory storage space. Such an embodiment may achieve this goal by removing certain default prefix extensions from a number before storing the number in the directory.

In the embodiment of FIG. 8, a portable electronic device 800 includes an internal memory 810 having a stored directory of numbers 812, as well as program code 814 for searching the directory. The device 800 also includes control logic 830 for carrying out various control operations. The device 800 may also include logic 832 for determining if a given prefix (of a received number) matches a default prefix. Logic 834 may also be provided for removing such a matching prefix, before storing a number into the directory. Removing a default prefix reduces the amount of storage space required for the number. Similarly, logic 836 may be provided for re-appending the removed default prefixes. In this regard, numbers retrieved from the directory 812, which do not have a prefix may be assumed to have had a default prefix that was removed before storage in the directory. Therefore, logic 836 replaces such previously removed prefixes.

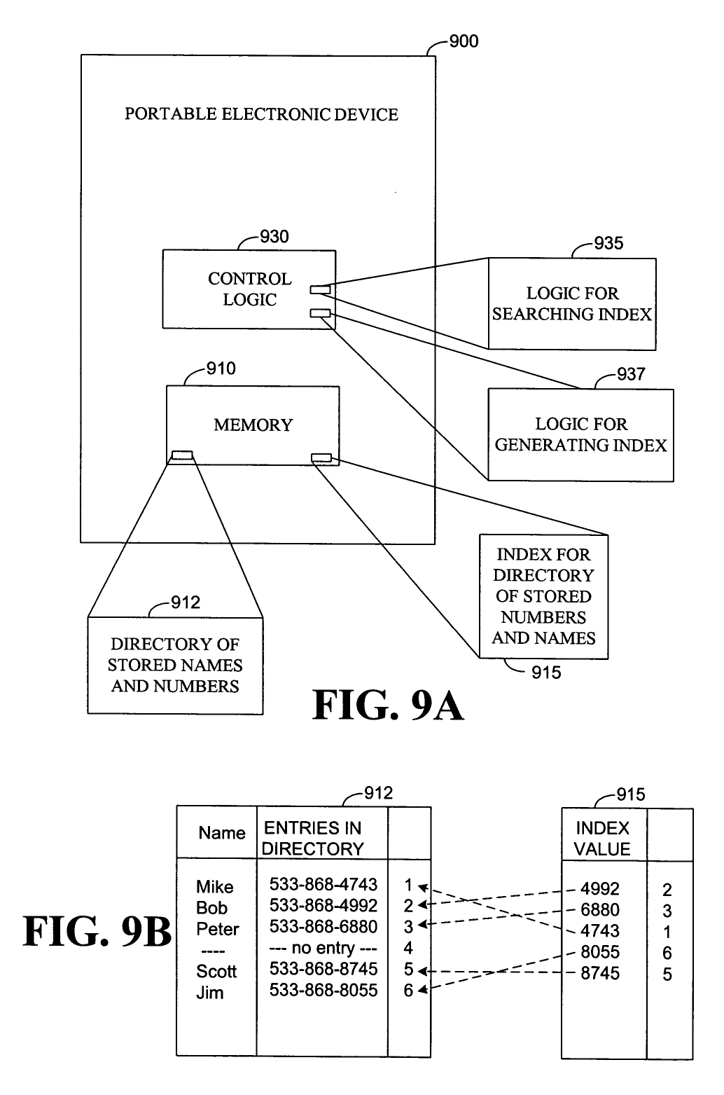

In accordance with another embodiment of the present invention, a searching algorithm may be implemented in an efficient manner by using an index table having abridged information covering the current contents of the stored directory of names and numbers. One such embodiment may be implemented as shown in FIGS. 9A and 9B. FIG. 9A illustrates a portable electronic device 900 having control logic 930 and memory 910, similar to the embodiment illustrated in FIG. 8. In addition, the memory 910 may include a directory of stored names and numbers 912. Although not specifically illustrated, a directory of stored names and numbers may also be provided in a SIM card that is coupled to the portable electronic device.

An index or the directory of stored names and numbers 915 may also be provided in the memory 910. One manner in which the index 915 may be implemented is illustrated in FIG. 9B. As shown, the directory 912 of names and numbers may include five entries. Although six entries are illustrated, the fourth entry location has no current contents residing in it. Such a situation may occur, for example, when a user deletes or otherwise removes an entry from the directory. A separate index 915 may be provided storing only a portion of the information of the directory 912. In one embodiment, the stored value of the index is the right most digits of the numbers stored in the directory. In the embodiment illustrated in FIG. 9B, the four rightmost digits are stored in the index 915. In alternative embodiments, fewer or additional digits may be used as the indexed value.

The index 915 also provides linking information to link or associate the index value to the matching value in the directory. The portable electronic device 900 may also include logic 937 for generating such an index 915. Likewise, the portable electronic device 900 may include logic 935 for searching the index 915. In this regard, embodiments of the invention have been described previously, in which a received number is searched against entries stored in a directory, by searching from the rightmost digit(s) in a generally leftward fashion. Likewise, in the embodiment illustrated in FIGS. 9A and 9B, the rightmost digit(s) of the received number may be searched against the values stored in the index 915. If more than one number stored in the directory has identical digits in the last four (or other) digit locations, then multiple entries will be identified from the index 915 having corresponding entries in the directory. When this results, further searching could be performed of the entire directory by making comparisons of additional digits of the received number with additional digits stored in the directory for numbers that are linked from the index 915.

The embodiment illustrated in FIGS. 9A and 9B illustrate yet another manner in which a generally right-to-left searching methodology may be implemented in accordance with an embodiment of the invention.

The foregoing description is not intended to be exhaustive or to limit the invention to the precise forms disclosed. Obvious modifications or variations are possible in light of the above teachings. Further, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly and legally entitled.

1. In a mobile phone, a method for searching a directory comprising a plurality of numbers to associate a received number with a stored directory entry, the method comprising:
a) receiving a number, the received number being defined by a plurality of digits;
b) selecting a rightmost digit of the received number as a current comparison digit;
c) comparing the current comparison digit with a corresponding digit of each of a plurality of numbers stored in the directory;
d) ending the search, if no matching digits are identified;
e) selecting, as a current comparison digit, a digit to the immediate left of a previous current comparison digit; and
f) repeating steps c through e, until a predetermined number of digits of the received number have been compared against the plurality of numbers stored in the directory.

2. The method of claim 1, wherein the predetermined number of digits comprises all of the digits of the received number.

3. The method of claim 1, wherein the directory is stored in a memory in the mobile phone.

4. The method of claim 1, wherein the directory is stored in a memory carried on a substrate that may be readily decoupled from the mobile phone.

5. The method of claim 1, further comprising displaying a directory entry associated with any matching numbers found in the directory.

6. The method of claim 1, wherein the comparing more specifically compares the current comparison digit as a character value.

7. The method of claim 1, wherein the comparing more specifically compares the current comparison digit as an integer value.

8. The method of claim 1, further including left filling digits of numbers stored in directory with default values, for the numbers stored in the directory that have fewer digits than the received number.

9. In a mobile phone, a method for searching a directory comprising a plurality of numbers to associate a received number with a stored directory entry, the method comprising:
a) receiving a number, the received number being defined by a plurality of segments;
b) selecting a rightmost segment of the received number as a current comparison segment;
c) comparing the current comparison segment with a corresponding segment of each of a plurality of numbers stored in the directory;
d) ending the search, if no matching segments are identified;
e) selecting, as a current comparison segment, a segment to the immediate left of a previous current comparison segment; and
f) repeating steps c through e, until a predetermined number of segments of the received number have been compared against the plurality of numbers stored in the directory.

10. The method of claim 9, wherein the predetermined number of segments comprises all segments of the received number.

11. The method of claim 9, further including left filling segments of numbers stored in directory with default values, for the numbers stored in the directory that have fewer segments than the received number.

12. The method of claim 9, further comprising displaying a directory entry associated with any matching numbers found in the directory.

13. The method of claim 9, wherein the step of receiving the number comprises receiving the number through a caller identification feature.

14. The method of claim 9, wherein the plurality of segments comprise a mobile country code (MCC) segment, a mobile network code (MNC) segment, and a mobile subscriber identification number (MSIN) segment, wherein the MSIN segment is the rightmost segment.

15. The method of claim 14, wherein the mobile phone includes a default value for the MCC segment and a default value for the MNC segment, and these default values are used as a part of the received number, if values for the MCC and MNC segments are not supplied with the received number.

16. The method of claim 14, wherein the mobile phone includes a default value for the MCC segment and a default value for the MNC segment, and these stored default values are used as a part of the stored numbers, for stored numbers that do not include stored values for the MCC and MNC segments

17. The method of claim 9, wherein the plurality of segments comprise a country code (CC) segment, a national destination code (NDC) segment, and a subscriber number (SN) segment, wherein the SN segment is the rightmost segment.

18. The method of claim 9, wherein a segment comprises a plurality of digits.

19. The method of claim 9, wherein a segment comprises a single digit.

20. The method of claim 9, wherein the comparison of step c is made by comparing the segments as character strings.

21. The method of claim 9, further comprising converting the current comparison segment to an integer value, wherein the comparison of step c is made by comparing the integer value with a corresponding value of a segment of each of the plurality of numbers stored in the directory.

22. A method of comparing a received number with a plurality of numbers stored in a directory coupled to a phone comprising comparing digits of the received number with digits of the stored numbers in a generally right to left direction; and discarding or ignoring comparisons stored numbers having digits that do not match the corresponding digits of the received number.

23. A method of storing a number in a directory for a mobile phone comprising:
directing a number to be stored in a directory to be associated with the mobile phone, the number comprising a base number and at least one prefix extension;
comparing a first prefix extension with a first corresponding default prefix extension; and
if the comparison of the first prefix extension and first default prefix extension indicates a match, then storing the base number in the directory, but not storing the first prefix extension in the directory.

24. The method of claim 23, further comprising:
comparing a second prefix extension with a second corresponding default prefix extension;
if the comparison of the second prefix extension and second default prefix extension indicates a match, then storing the base number in the directory, but not storing the second prefix extension in the directory.

25. The method of claim 23, wherein the directory is stored in a memory in the mobile phone.

26. The method of claim 23, wherein the directory is stored in a memory carried on a substrate that may be readily decoupled from the mobile phone.

27. The method of claim 26, wherein the substrated is a SIM card.

28. A mobile phone comprising:
receive logic to receive a number;
select logic to select a rightmost digit of the received number as a current comparison digit;
compare logic configured to compare the current comparison digit with a corresponding digit of each of a plurality of numbers stored in a directory;
revised selection logic configured to select, as a current comparison digit, a digit to the immediate left of a previous current comparison digit; and
control logic to control the compare logic to compare up to all digits of the received number with corresponding digits of a plurality of numbers stored in the directory, the control logic configured to terminate the comparison when either a matching number is identified or it is concluded that no number of the plurality of numbers matches the received number.

29. The mobile phone of claim 28, further comprising logic to display a directory entry associated with any matching numbers found in the directory.

30. The mobile phone of claim 28, wherein the compare logic is more specifically configured to compare the current comparison digit as a character value.

31. The mobile phone of claim 28, wherein the compare logic is more specifically configured to compare the current comparison digit as an integer value.

32. The mobile phone of claim 28, further including logic to left-fill digits of numbers stored in directory with default values, for the numbers stored in the directory that have fewer digits than the received number.

33. A mobile phone comprising:
logic to store a number in a directory associated with the mobile phone, the number comprising a base number and at least one prefix extension;
logic to compare a first prefix extension with a first corresponding default prefix extension; and
logic, responsive to a match determined by the compare logic, to store the base number in the directory, but not store the first prefix extension in the directory.

34. A mobile phone comprising:
receive logic to receive a number, the received number defined by a plurality of segments; and
compare logic to compare the received number with a plurality of numbers stored in the directory on a segment by segment basis, beginning with the rightmost segment and moving leftward, until either a match is identified, or until each of the plurality of stored numbers is excluded from being a match to the received number.

35. The mobile phone of claim 34, further comprising logic to display a directory entry associated with any matching numbers found in the directory.

36. The mobile phone of claim 34, wherein the receive logic is configured to receive the number through a caller identification feature.

37. The mobile phone of claim 34, wherein the plurality of segments comprise a mobile country code (MCC) segment, a mobile network code (MNC) segment, and a mobile subscriber identification number (MSIN) segment, wherein the MSIN segment is the rightmost segment.

38. The mobile phone of claim 37, further including a stored default value for the MCC segment and a stored default value for the MNC segment, and these stored default values are used as a part of the received number, if values for the MCC and MNC segments are not supplied with the received number.

39. The mobile phone of claim 37, further including a stored default value for the MCC segment and a stored default value for the MNC segment, and these stored default values are used as a part of the stored numbers, for stored numbers that do not include stored values for the MCC and MNC segments.

40. The mobile phone of claim 34, wherein the plurality of segments comprise a country code (CC) segment, a national destination code (NDC) segment, and a subscriber number (SN) segment, wherein the SN segment is the rightmost segment.

41. A portable electronic device comprising:
receive logic to receive a number;
logic to generate an index containing a plurality of abridged numbers, said abridged numbers containing only a rightmost portion of numbers stored in a directory of numbers within the portable electronic device, the index further comprising a mechanism to associated the abridged numbers with a corresponding number in the directory;
logic for comparing the received number with the plurality of abridged numbers.
